(19) United States
(12) Patent Application Publication
(10) Pub. No.: US 2026/0046987 A1
(43) Pub. Date: Feb. 12, 2026

(54) Universal and Adjustable Mechanism for Mounting a Microwave Oven

(71) Applicant: Latoya Danene Reed, Mobile, AL (US)

(72) Inventor: Latoya Danene Reed, Mobile, AL (US)

(21) Appl. No.: 19/328,468

(22) Filed: Sep. 15, 2025

Related U.S. Application Data
(63) Continuation-in-part of application No. 18/542,678, filed on Dec. 16, 2023, now Pat. No. 12,439,485.

(51) Int. Cl. H05B 6/64; F16M 13/02

(52) U.S. Cl. CPC H05B 6/6429; F16M 13/022

(57) ABSTRACT

The present subject matter pertains to a mechanism for mounting a microwave oven, suitable to secure a microwave oven to a wall or a support surface, while enabling vertical and horizontal movement of a microwave oven via user-operated devices. The present disclosure comprises four main segments: a microwave oven mounting segment, an extending/retracting segment, a supporting plate segment, and a wall mounting segment. The microwave oven mounting segment, consisting of mounting brackets and a mounting plate configured to connect a microwave oven to the mounting mechanism. The extending/retracting segment, which consists of a horizontal mechanism and a vertical mechanism that allows at least vertical and horizontal movement. The supporting plate segment includes three vertical support plates configured to support the components of the extending/retracting segment, thereby enabling a microwave oven to be lifted and/or lowered. Finally, the wall mounting segment secures the mechanism to a wall or a support surface.

### CROSS REFERENCE TO RELATED APPLICATION

The present application is a Continuation-In-Part of co-pending application U.S. Nonprovisional application Ser. No. 18/542,678 filed on Dec. 16, 2023, by the same inventor, Latoya Danene Recd.

### TECHNICAL FIELD OF THE INVENTION

The disclosed invention relates to the general field of microwave oven appliances, more specifically to an apparatus for mounting a microwave oven to a wall or to other support surfaces. The present disclosure can also be used to mount a display, such as electronic devices, to a wall or to other support surfaces.

### BACKGROUND OF THE INVENTION

The present subject matter primarily relates to devices for supporting a microwave oven. Prior arts are relatively simple in construction and primarily created to mount a microwave oven above or below objects, such as a stove or a kitchen cabinet. However, prior arts only allow a microwave oven to remain stationary, being mounted in relatively high or low positions, making it difficult for microwave oven users to reach and/or access a microwave oven.

To resolve this issue of microwave oven inaccessibility, it is essential for a more complex mounting device to be created. One such design is depicted in U.S. Nonprovisional application Ser. No. 18/542,678, which shows an adjustable microwave oven mounting apparatus for mounting a microwave oven to a wall or a support surface, which includes an extending/retracting segment configured to allow at least vertical and horizontal movement. This apparatus, however, has a greater possibility of colliding into objects/obstacles, such as a kitchen counter or a stove, when lifting or lowering a microwave oven.

Thus, it is necessary to provide an apparatus that will allow the user to safely lift or lower a microwave oven while avoiding colliding into objects/obstacles. The present disclosure is equipped with features, such as the supporting plate segment, which will enable a microwave oven to be lifted and/or lowered in such a way that avoids hitting or striking other objects/obstacles such as stoves, ranges, cooking tops, kitchen counters, kitchen cabinets, etc. Moreover, prior arts are usually specific to each microwave oven brand or microwave oven type. The prior art depicted in U.S. Nonprovisional application Ser. No. 18/542,678 shows an adjustable microwave oven mounting apparatus that is universal and includes a microwave oven mounting segment configured to attach to and accommodate virtually any microwave oven type or brand. The present disclosure is also a universal mounting apparatus configured to attach to and accommodate virtually any microwave oven type or brand. However, the present disclosure is equipped with a more sophisticated microwave oven mounting segment which will streamline the microwave oven mounting process. For example, the present disclosure includes an adjustable microwave oven mounting plate configured to extend and to retract. This feature allows the microwave oven mounting segment to adjust to the dimensions of virtually any microwave oven, no matter how small or large a microwave oven may be, which makes it easier for the user or the installer to align and connect the microwave oven mounting plate to a microwave oven.

### BRIEF DESCRIPTION OF INVENTION

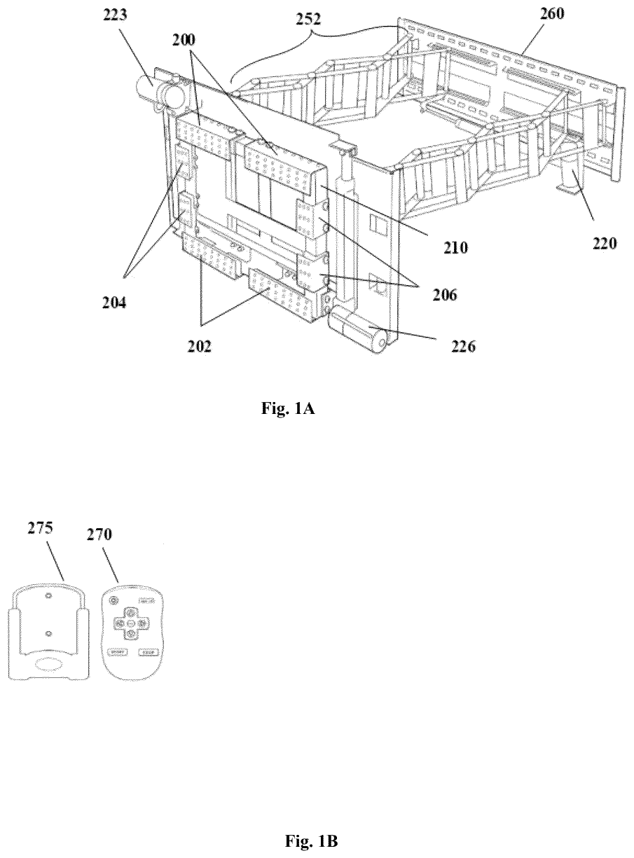

FIG. 1A is a three-dimensional view of the preferred embodiment of the present subject matter. FIG. 1B is a three-dimensional view of the present disclosure depicting a wireless remote control device and a remote control pouch.

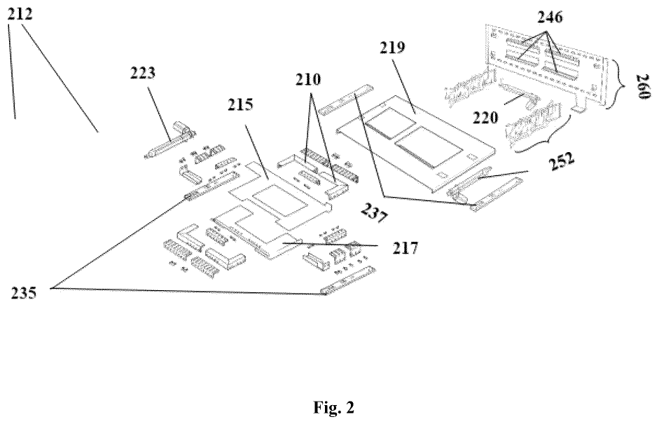

FIG. 2 is an exploded view of the present disclosure.

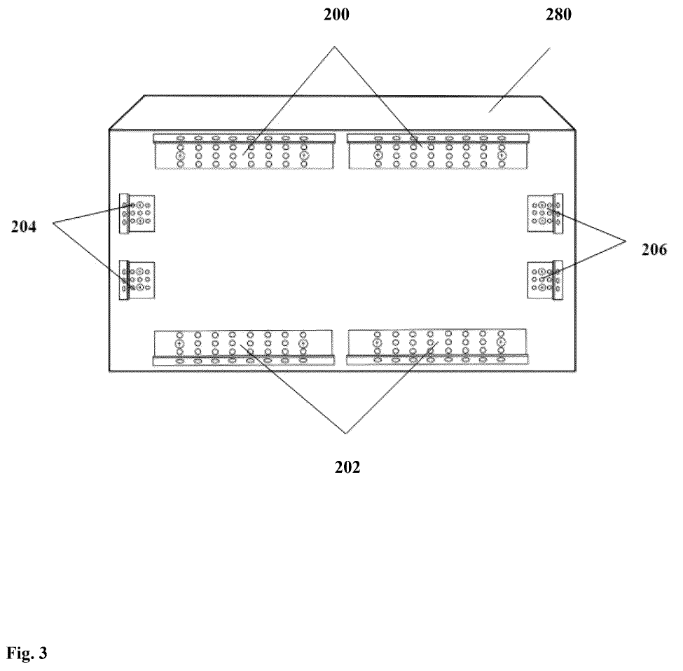

FIG. 3 is a three-dimensional view of the microwave oven mounting brackets shown attached to the rear side of a microwave oven according to an embodiment of the present subject matter.

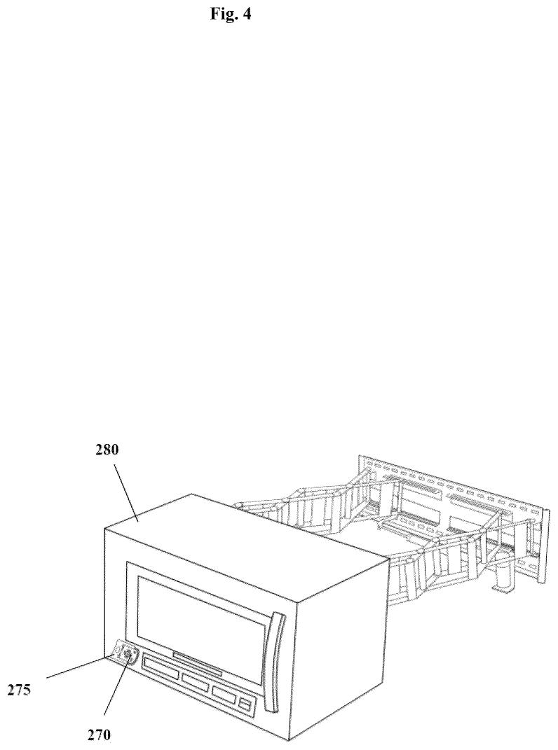

FIG. 4 is a perspective view of the present disclosure depicting a microwave oven attached.

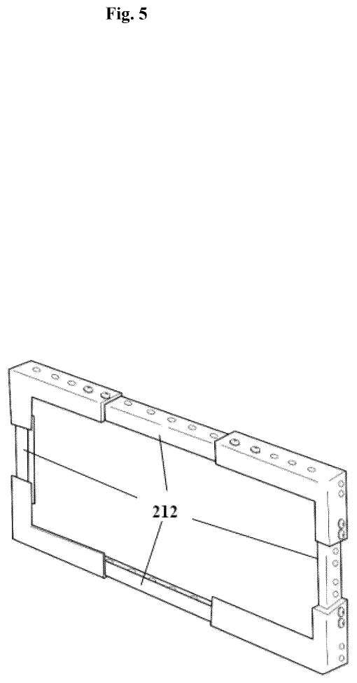

FIG. 5 is a three-dimensional view of the microwave oven mounting plate according to an embodiment present subject matter.

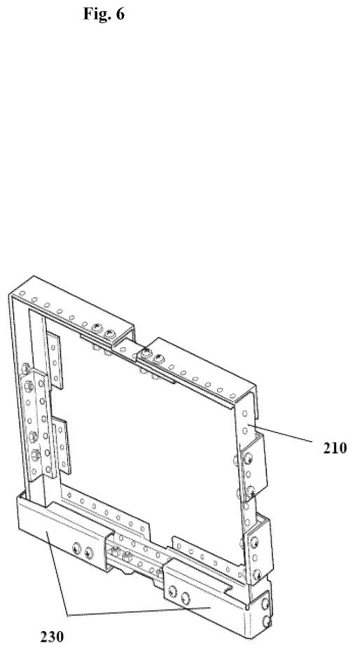

FIG. 6 is a perspective view of the microwave oven mounting segment showing the back brackets attached according to an embodiment of the present subject matter.

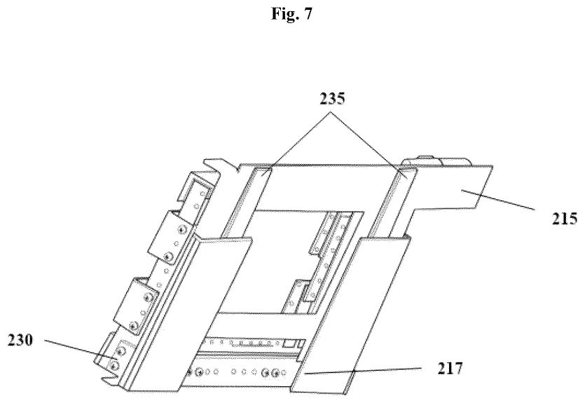

FIG. 7 is a partial view of the vertical mechanism according to an embodiment of the present subject matter.

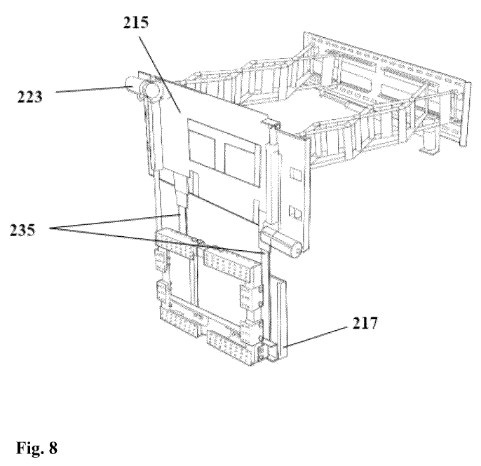

FIG. 8 is a three-dimensional view of the present disclosure in a lowered configuration.

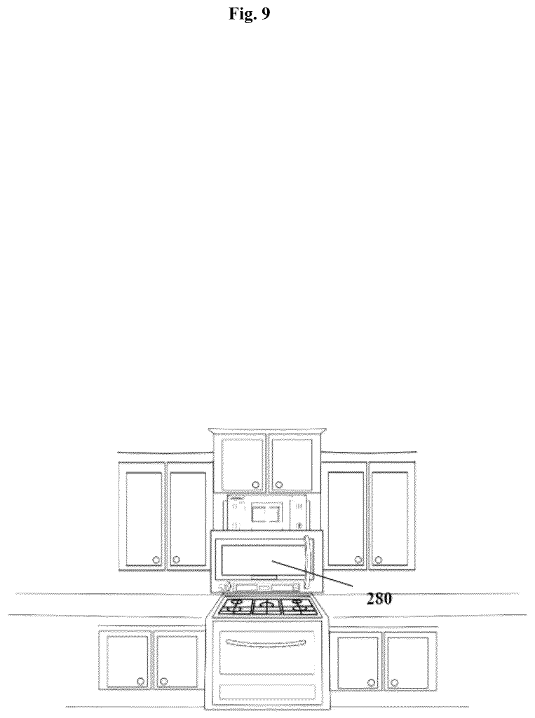

FIG. 9 is a perspective view of the present disclosure depicting a high-positioned microwave oven being lowered by the present subject matter.

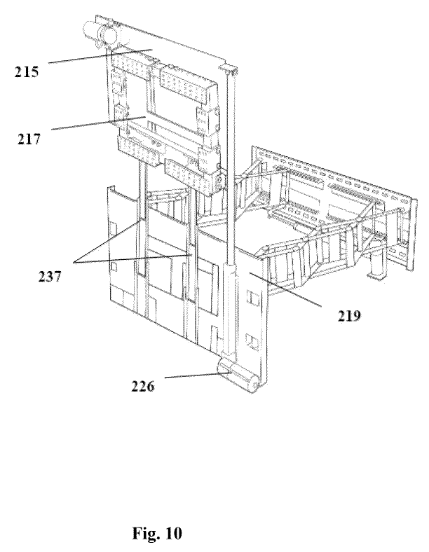

FIG. 10 is a three-dimensional view of the present disclosure in a raised configuration.

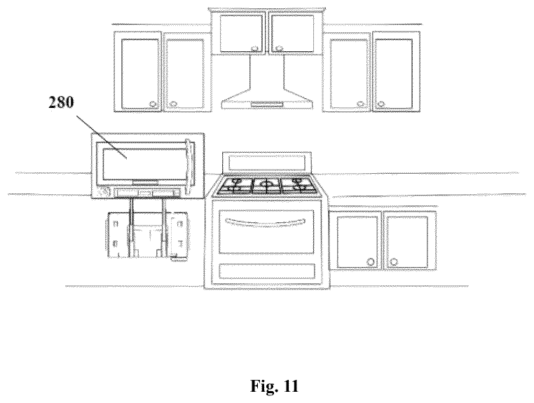

FIG. 11 is a perspective view of the present disclosure depicting a low-positioned microwave oven being raised by the present subject matter.

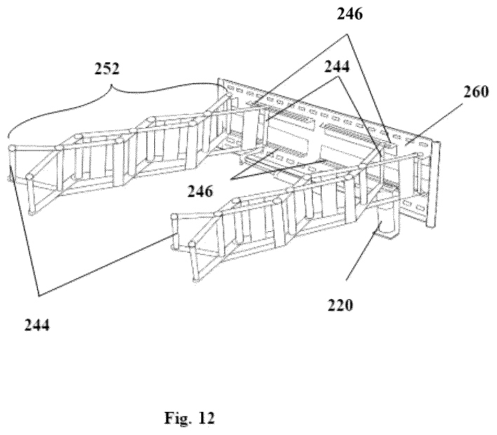

FIG. 12 is a perspective view of the horizontal mechanism according to an embodiment of the present subject matter in an extended configuration.

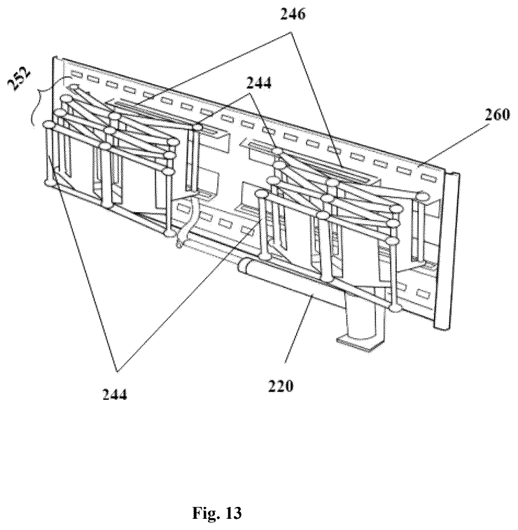

FIG. 13 is a perspective view of the horizontal mechanism according to an embodiment of the present subject matter in a retracted configuration.

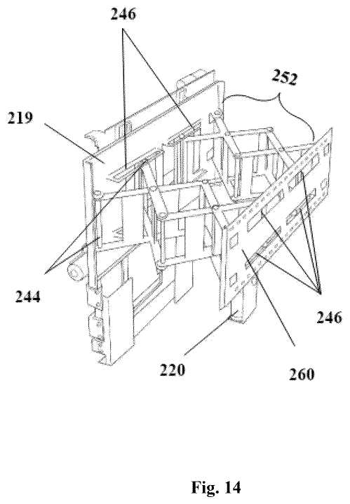

FIG. 14 is a three-dimensional rear view of the present subject matter.

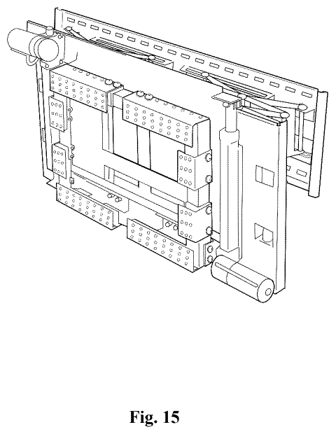

FIG. 15 is a three-dimensional view of the present subject matter in a retracted configuration.

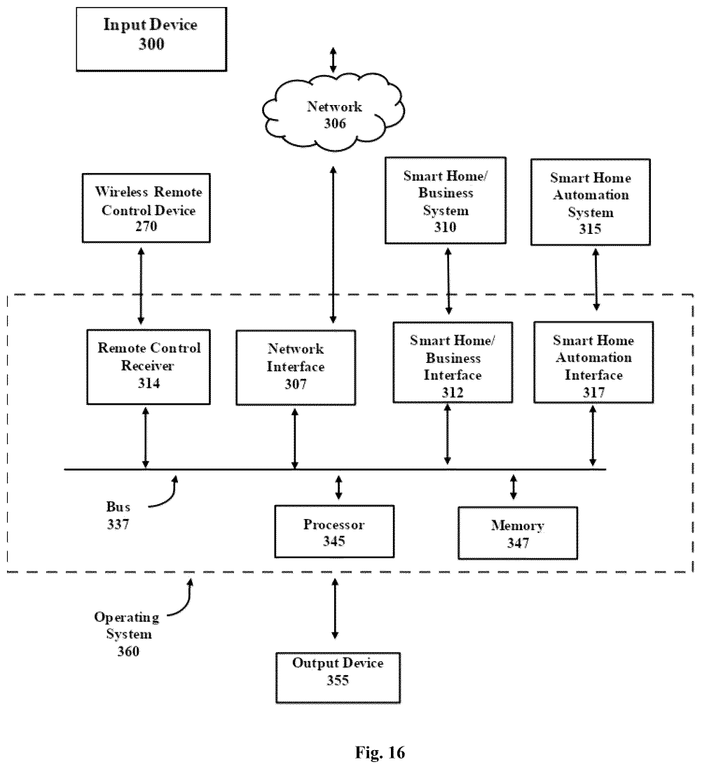

FIG. 16 is a diagram of an operating system according to an embodiment of the present subject matter.

### DETAILED DESCRIPTION OF THE INVENTION

Herein, the preferred embodiment of the invention is described in some detail. However, it is important to understand that the preferred embodiment used to illustrate the invention is not intended to limit the invention but was created as an example only. Also, the terminology used in this document merely describes the preferred embodiment presented herein and is not intended to limit the scope of the invention. It should be understood that the present disclosure can be implemented in various ways, and that modifications, variations, or changes to the preferred embodiment are possible without departing from the subject matter which is defined by the formal claims included within this document.

The present disclosure is a universal and adjustable mechanism that is suitable for mounting a microwave oven to a wall or to a support surface, especially over a cooking top, under a kitchen counter or cabinet, or around other objects and/or obstacles, while providing vertical and horizontal movement for a microwave oven. By using a wireless remote control device or a connected device (i.e. smartphone or tablet), the user can signal the present invention to adjust the position of a microwave oven, such as lowering or lifting a microwave oven, thereby making the microwave oven more accessible to the user.

In this section of the document, various aspects of the present invention can be further comprehended as it will be described more clearly and completely hereinafter with reference to the accompanying drawings. Many aspects of the subject matter are described more thoroughly by referencing the correlating numbers shown in the illustrations of the embodiment of the present invention. Unless otherwise noted, the left and right sides of the subject matter that are depicted are mirror images and identical. The illustrations that are included in this document are solely to describe the subject matter and depict only certain selected embodiments of the subject matter and should not be interpreted as limiting the scope of the invention. The steps, methods, sizes, shapes, measurements, positions, arrangements, and orientations of the present subject matter, including its variations and alternative embodiments, can be adjusted as necessary or as desired, including but not limited to the addition or elimination of certain aspects and components. It is important to note that while the present invention can encompass numerous versions, methods, steps, alternatives, and variations, this document will refrain from stating and describing each version, method, step, alternative, and variation in the interest of brevity.

FIG. 1A is a three-dimensional view of the preferred embodiment of the present subject matter. FIG. 1B is a three-dimensional view of the present disclosure depicting a wireless remote control device and a remote control pouch. FIG. 1A depicts the preferred embodiment of the present subject matter which consists of four main segments: a microwave oven mounting segment, an extending/retracting segment, a supporting plate segment, and a wall mounting segment. The microwave oven mounting segment includes microwave oven mounting brackets and a microwave oven mounting plate 210. The microwave oven mounting brackets include upper brackets 200, lower brackets 202, left brackets 204, and right brackets 206 which are attached to the rear side of a microwave oven's upper, lower, left, and right sides, respectively. The microwave oven mounting brackets consist of numerous screw holes configured to use when bolting the microwave oven mounting brackets to the rear side of a microwave oven 280. The microwave oven mounting brackets can also be used in various combinations or arrangements to accommodate various types and brands of microwave ovens. This feature provides the present invention with both universal applicability and versatility. After attaching to the rear side of a microwave oven, the microwave oven mounting brackets, subsequently, connect to the microwave oven mounting plate 210. The microwave oven mounting plate 210 is then used to facilitate the connection of a microwave oven to the present disclosure.

The extending/retracting segment consists of two mechanisms, a horizontal mechanism and a vertical mechanism, configured to allow the present subject matter to move at least horizontally and vertically and to also pivot a microwave oven around objects and/or obstacles. The horizontal mechanism consists of a motorized actuator (the first actuator 220) and a linkage mechanism 252. The first actuator 220 permits the present disclosure to move a microwave oven horizontally, including moving to and from a wall or other support surfaces. As the first actuator 220 extends, it causes the linkage mechanism 252 to extend, thereby moving a microwave oven forward and away from a wall or other support surfaces. As the first actuator 220 retracts, it causes the linkage mechanism 252 to retract as well, thus moving a microwave oven horizontally and back towards a wall or other support surfaces, including moving back to its initial/original mounted position.

The vertical mechanism consists of two motorized actuators (the second actuator 223 and the third actuator 226) and mechanical slides that allow at least vertical movement for the present invention. The mechanical slides will be discussed in more detail later in FIG. 2. The second actuator 223 permits the present subject matter to lower a microwave oven. As the second actuator 223 extends, it causes the present subject matter to move downward, thereby lowering a microwave oven. As the second actuator 223 retracts, it causes the present subject matter to move upward, thereby lifting a microwave oven, including moving back to its initial/original mounted position. The third actuator 226 permits the present subject matter to raise a microwave oven. Therefore, as the third actuator 226 extends, it causes the present subject matter to move upward, thereby lifting a microwave oven. Conversely, when the third actuator 226 retracts, it causes present subject matter to move downward, thereby lowering a microwave oven, including moving back to its initial/original mounted position.

Furthermore, FIG. 1B depicts a wireless remote control device 270, configured to control the operation of the present invention. The wireless remote control device 270 sends signals to the present invention, triggering specific functions, such as raising or lowering a microwave oven. The wireless remote control device 270 is accompanied by a remote control pouch 275 configured to store the wireless remote control device 270. At the user's discretion, the remote control pouch 275 can attach to surfaces, such as the surface of a microwave oven. The remote control pouch 275 also ensures that the wireless remote control device 270 is readily accessible to the user, as the remote control pouch 275 (which stores the wireless remote control device 270) can be placed in the user's preferred location.

The wall mounting segment depicted in FIG. 1A consists of a wall mounting plate 260 configured to secure the present invention to a wall or to other support surfaces. The wall mounting plate 260 consists of multiple holes that are used to fasten the wall mounting plate 260 to a wall or other support surfaces, preferably using wall studs. Alternatively, other methods, including but not limited to heavy duty drywall anchors, fasteners, or adhesives can be used to secure the wall mounting plate 260 to a wall or to other support surfaces. The wall mounting plate 260 also supports the components of the horizontal mechanism, including the first actuator 220 and the linkage mechanism 252.

FIG. 2 is an exploded view of the present disclosure. In this figure, the microwave oven mounting plate 210 is shown in an exploded view. The upper and lower aspects of the microwave oven mounting plate 210 are identical and the left and right aspects of the microwave oven mounting plate are also identical. The microwave oven mounting plate 210 consists of middle brackets 212 that are located on the upper, lower, left, and right sides of the microwave oven mounting plate 210. Moreover, the supporting plate segment is depicted more clearly in this figure. The supporting plate segment is configured to support the components of the extending/retracting segment, specifically it provides support primarily to the extending/retracting components of the vertical mechanism, thereby allowing at least vertical movement for the present disclosure, such as lifting and lowering a microwave oven. The supporting plate segment also helps support the linkage hinge mechanism 252, thus allowing at least horizontal movement for the present disclosure. The supporting plate segment consists of three vertical support plates: a first vertical support plate 215, a second vertical support plate 217, and a third vertical support plate 219. The first vertical support plate 215 is positioned between the microwave oven mounting segment (specifically the microwave oven mounting plate 210), and the second vertical support plate 217. The first vertical support plate 215 consists of the second actuator 223 and the first mechanical slides 235. The second vertical support plate 217 is attached to the microwave oven mounting segment (specifically to the microwave oven mounting plate 210). The second actuator 223 is attached to the upper portion of the first vertical support plate 215 and the lower portion of the second vertical support plate 217. The second actuator 223 allows the first vertical support plate 215 and the second vertical support plate 217 to move about each other, meaning that the second actuator 223 moves the second vertical support plate 217 relative to the first vertical support plate 215. Therefore, as the second actuator 223 extends, it pushes against the second vertical support plate 217, causing the first mechanical slides 235 to extend downward, triggering the second vertical support plate 217 to move the attached microwave oven mounting segment (specifically the microwave oven mounting plate 210) downward, thereby lowering a microwave oven. Conversely, as the second actuator 223 retracts, it pulls the second vertical support plate 217, causing the first mechanical slides 235 to retract upward, triggering the second vertical support plate 217 with the attached microwave oven mounting segment to move vertically upward, thereby lifting a microwave oven, including moving a microwave oven back to its initial/original mounted position.

This figure shows the third vertical support plate 219 which is positioned between the second vertical support plate 217 and the linkage mechanism 252. The third vertical support plate 219 consists of the third actuator 226 and the second mechanical slides 237. The third actuator 226 allows the third vertical support plate 219 and the first vertical support plate 215 to move about each other, meaning that the third actuator 226 moves the first vertical support plate 215 relative to the third vertical support plate 219. Therefore, as the third actuator 226 extends up, it pushes against the first vertical support plate 215, causing the second mechanical slides 237 to extend upward, triggering the first vertical support plate 215, which is attached to the second vertical support plate 217 and thus connected to the microwave oven mounting segment, to move vertically upward, thereby lifting a microwave oven. Conversely, as the third actuator 226 retracts, it pulls the first vertical support plate 215, causing the second mechanical slides 237 to retract downward, triggering the first vertical support plate 215, which is attached to the second vertical support plate 217 and thus connected to the microwave oven mounting segment, to move vertically downward, thereby lowering a microwave oven, including moving a microwave oven back to its initial/original mounted position.

The drawing further depicts the horizontal mechanism where certain aspects of the present disclosure can be seen in more detail. As the first actuator 220 extends, it pushes against the linkage mechanism 252, causing the linkage mechanism 252 to slide across slots 246 located on the wall mounting plate 260, thereby triggering the linkage mechanism 252 to extend horizontally and move away from a wall or other support surfaces. Conversely, as the first actuator 220 retracts, it causes the linkage mechanism 252 to slide across the slots 246, triggering the linkage mechanism 252 to retract horizontally and move back towards a wall or other support surfaces. It is important to note that the linkage mechanism 252 simultaneously slides across slots 246 located on both the wall mounting plate 260 and the third vertical support plate 219 when extending and retracting. The slots located on the third vertical support plate 219 will be depicted in FIG. 12, FIG. 13, and FIG. 14.

FIG. 3 is a three-dimensional view of the microwave oven mounting brackets shown attached to the rear side of a microwave oven according to an embodiment of the present subject matter. This drawing illustrates the microwave oven mounting brackets (upper brackets 200, lower brackets 202, left brackets 204, and right brackets 206) attached to the rear side of a microwave oven's 280 upper, lower, left and right sides, respectively. The screw holes located on the microwave oven mounting brackets align with the screw holes located on the rear side of a microwave oven 280 and the microwave oven mounting brackets are, then, secured on the rear side of a microwave oven 280 via bolting.

FIG. 4 is a perspective view of the present disclosure depicting a microwave oven attached. In this figure, a microwave oven 280 is secured to the present disclosure, whereas the remote control pouch 275 is shown attached to a microwave oven 280 holding the wireless remote control device 270. Ideally, the remote control pouch 275 attaches to a microwave oven 280 or to other surfaces preferably using an adhesive. However, other methods can be used to affix the remote control pouch 275 to a microwave oven 280 or to other surfaces, including but not limited to magnetism, suctioning, fasteners, or anchors. Alternatively, the remote control pouch 275 and the wireless remote control device 270 can remain detached from a microwave oven 280 or other surfaces.

FIG. 5 is a three-dimensional view of the microwave oven mounting plate according to an embodiment present subject matter. The microwave oven mounting plate 210 is capable of extending and retracting on all sides, adjusting its length as needed. The microwave oven mounting plate 210 consists of middle brackets 212 that are located on each side of the microwave oven mounting plate 210, with one middle bracket 212 per side. These middle brackets 212 enable the microwave oven mounting plate 210 to lengthen and shorten on all sides. Once the desired length is achieved, the middle brackets 212 are then fastened to the microwave oven mounting plate 210 to secure the desired length. The adjustability functionality of the microwave oven mounting plate 210 allows the present disclosure to fit and adapt to the dimensions of a variety of microwave ovens 280. The combination of the adjustable feature of the microwave oven mounting plate 210 with universal and versatile functionalities of the microwave oven mounting brackets, ensures the present disclosure's compatibility with various types and brands of microwave ovens 280.

FIG. 6 is a perspective view of the microwave oven mounting segment showing the back brackets 230 attached according to an embodiment of the present subject matter. The back brackets 230 are bolted between the microwave oven mounting plate 210 and the second vertical support plate 217. However, in this drawing, the second vertical support plate 217 has been removed for the purpose of obtaining a better view of the back brackets 230. The back brackets 230 are configured to secure the microwave oven mounting segment to the present disclosure. More specifically, the back brackets 230 allow the microwave oven mounting plate 210 to adjust its lengths, and subsequently, facilitate the connection of the microwave oven mounting plate 210 to the second vertical support plate 217. Therefore, once the microwave oven mounting plate 210 is adjusted to the desired length, the back brackets 230 are, then, attached to the microwave oven mounting plate 210. Afterwards, the back brackets 230 (that are now attached to the microwave oven mounting plate 210) are then connected 210 to the present disclosure by attaching to the second vertical support plate 217. Additionally, or alternatively, there can be another set of back brackets 230 configured to provide additional support and stability for the present disclosure. It is imperative to mention that the present disclosure may comprise one back bracket 230 or multiple back brackets 230. It is also imperative to mention that the present disclosure may function without the back brackets 230. For example, in this alternative embodiment, the back brackets 230 would be eliminated and the microwave oven mounting plate 210 attaches directly to the second vertical support plate 217.

FIG. 7 is a partial view of the vertical mechanism according to an embodiment of the present subject matter. In this view, the back brackets 230 are shown attached between the microwave oven mounting plate 210 and the second vertical support plate 217. Also, the first mechanical slides 235 are attached between the first vertical support plate 215 and the second vertical support plate 217. Because the back brackets 230 are bolted between the microwave oven mounting plate 210 and the second vertical support plate 217, only a partial view of the back brackets 230 can be seen in this view. The full view of the back brackets 230 are better seen in FIG. 6, wherein the second vertical support plate 217 has been removed.

FIG. 8 is a three-dimensional view of the present disclosure in a lowered configuration. In this illustration, the vertical mechanism is shown in a lowered configuration, whereas the second actuator 223 and the first mechanical slides 235 are shown in an extended configuration, thereby lowering the microwave oven mounting segment. The first mechanical slides 235 connect the second vertical support plate 217 to the first vertical support plate 215. The second actuator 223 is attached to the first vertical support plate 215, and as the second actuator 223 extends, it pushes down on the second vertical support plate 217, causing the first mechanical slides 235 to extend downward, subsequently moving the second vertical support plate 217, with the attached microwave oven mounting segment, downward as well, thereby lowering a microwave oven 280. Conversely, when the second actuator 223 retracts, it causes the first mechanical slides 235 to retract upward, thereby moving the second vertical support plate 217, with the attached microwave oven mounting segment, upward as well, thereby raising a microwave oven 280. When the second actuator 223 is fully retracted, the first mechanical slides 235 will also fully retract, causing the second vertical support plate 217 to help move a microwave oven 280 vertically upward and back to its initial/original mounted position.

FIG. 9 is a perspective view of the present disclosure depicting a high-positioned microwave oven being lowered by the present subject matter. Microwave ovens 280 that are mounted in relatively high positions, such as an over-the-range microwave oven 280, can be difficult for certain users, such as those who are short in stature, to reach. In this view, an over-the-range microwave oven 280 is shown lowered from its initial/original mounted position. To lower a microwave oven 280 for better access, the user can use a wireless remote control device 270 or a connected device, such as a smartphone, to communicate with the present disclosure to lower a microwave oven 280.

FIG. 10 is a three-dimensional view of the present disclosure in a raised configuration. In this illustration, the vertical mechanism is shown in a raised configuration, whereas the third actuator 226 and the second mechanical slides 237 are shown in an extended configuration, thereby raising the microwave oven mounting segment. The second mechanical slides 237 connect the first vertical support plate 215 to the third vertical support plate 219. The third actuator 226 and the second mechanical slides 237 are mounted to the third vertical support plate 219. The third actuator 226 is also connected between the first vertical support plate 215 and the third vertical support plate 219, and as the third actuator 226 extends, it pushes against the first vertical support plate 215, causing the second mechanical slides 237 to extend upward, triggering the first vertical support plate 215 (which is attached to the second vertical support plate 217 and, thus, connected to the microwave oven mounting segment), to move vertically upward, thereby lifting a microwave oven 280. Conversely, as the third actuator 226 retracts, it pulls the first vertical support plate 215, causing the second mechanical slides 237 to retract downward, triggering the first vertical support plate 215 to move vertically downward, thereby lowering a microwave oven 280. When the third actuator 226 is fully retracted, the second mechanical slides 237 will also fully retract, causing the first vertical support plate 215 to help move a microwave oven 280 vertically downward and back to its initial/original mounted position.

FIG. 11 is a perspective view of the present disclosure depicting a low-positioned microwave oven being raised by the present subject matter. Microwave ovens 280 that are mounted in relatively low positions, such as an undercounter microwave oven 280, can be difficult for certain users, such as those who are tall in stature or with a disability, to reach. In this view, an undercounter microwave oven 280 is shown lifted from its initial/original mounted position. To raise a microwave oven 280 for better access, the user can use a wireless remote control device 270 or a connected device, such as a smartphone, to communicate with the present disclosure to raise a microwave oven 280.

FIG. 12 is a perspective view of the horizontal mechanism according to an embodiment of the present subject matter in an extended configuration. In this drawing, the first actuator 220 and the linkage mechanism 252 are shown in an extended configuration. As the first actuator 220 extends, it pushes against the linkage mechanism 252, causing the linkage mechanism 252 to extend out horizontally. More specifically, as the first actuator 220 pushes against the linkage mechanism 252, it causes the pins 244 that are located on the frontend and backend of the linkage mechanism 252 to slide across the slots 246 located on the third vertical support plate 219 and the wall mounting plate 260, triggering the linkage mechanism 252 to extend horizontally. Consequently, as the horizontal mechanism extends, it causes the vertical mechanism to move horizontally and away from a wall or other support surfaces. Though not depicted in this illustration, FIG. 14 shows the slots 246 located on the third vertical support plate 219.

FIG. 13 is a perspective view of the horizontal mechanism according to an embodiment of the present subject matter in a retracted configuration. This illustration shows the first actuator 220 and the linkage mechanism 252 in a fully retracted configuration. As the first actuator 220 retracts, it pulls back the linkage mechanism 252, causing the linkage mechanism 235 to retract as well. More specifically, as the first actuator 220 pulls back the linkage mechanism 252, it causes the pins 244 located on the frontend and backend of the linkage mechanism 252 to slide across the slots 246 located on the third vertical support plate 219 and wall mounting plate 260, triggering the linkage mechanism 252 to retract horizontally. Consequently, as the horizontal mechanism retracts, it causes the vertical mechanism to move horizontally and back towards a wall or other support surfaces. Though not depicted in this illustration, FIG. 14 shows the slots 246 located on the third vertical support plate 219.

FIG. 14 is a three-dimensional rear view of the present subject matter. This drawing depicts a view of the rear side of the present disclosure, and particularly illustrates the linkage mechanism 252 located between the wall mounting plate 260 and the third vertical support plate 219, whereas the frontend of the linkage mechanism 252 is attached to the backend of the third vertical support plate 219 and the backend of the linkage mechanism 252 is attached to the frontend of the wall mounting plate 260. As the first actuator 220 extends or retracts, it causes the pins 244 located on both the frontend and the backend of the linkage mechanism 252 to slide simultaneously across the slots 246 located on the third vertical support plate 219 and the wall mounting plate 260, causing the linkage mechanism 252 to extend or retract, respectively, as well.

FIG. 15 is a three-dimensional view of the present subject matter in a retracted configuration. This drawing illustrates the present disclosure in a fully retracted state, whereas the extending/retracting components (actuators, linkage mechanism 252, and mechanical slides) are fully retracted. This configuration is typically seen when the embodiment is in its initial/original mounted position and moved back towards a wall or other support surfaces.

FIG. 16 is a diagram of an operating system according to an embodiment of the present subject matter. The operating system 360 is configured to control the operation of the present disclosure. The operating system 360 can include, but is not limited to, one or more processor(s) 345, memory 347, and programmable input/output (I/O) peripherals. The processor 345, such as a CPU, microcontroller, or microprocessor, processes and responds to various data and instructions/commands that direct the functions of the present disclosure, such as raising or lowering a microwave oven 280. The memory 347 stores data and instructions/commands for processing. The operating system 360 can consist of program memory and data memory, whereas program memory is non-volatile memory which stores long-term data, and data memory is volatile memory which stores temporary data. The operating system 360 can also use volatile memory types such as random-access memory (RAM) and non-volatile memory types such as read-only memory (ROM).

Input/Output (I/O) peripherals are input/output devices that enable the users, and other systems as well, to communicate with the operating system 360. Input devices 300 include, but are not limited to touchscreens, keyboards, computer mice, microphones, and sensors. Input devices 300 can also include connected devices, such as a smartphone or tablet/pad, which are user-operated devices that send data and/or commands to the operating system 360 for performing tasks. Output devices 355, such as actuators, monitors, speakers, printers, projectors, and global positioning systems (GPS), receive data and/or commands from the processor 345, and this data and/or commands are then presented to the user in a human-readable format. Essentially, output devices 355 takes data and/or commands from the processor 345 and convert it into a form that is perceivable, such as a visual, auditory, or physical output. For instance, actuators convert data and/commands from the processor 345 into physical actions, such as raising or lowering a microwave oven 280. Therefore, to raise or lower a microwave oven 280, for example, the user would use a smartphone (input device 300) to send data and/or commands to the operating system 360. The processor 345 receives and processes this data and/or command and subsequently communicates with the actuator (output device 355) to raise or lower a microwave oven 280. Furthermore, the network interface 307 is a connection point within the operating system 360 that allows data to be transferred between the operating system 360 and external devices or peripherals. An input device 300, such as a smartphone, utilizes a network 306 (i.e. internet, WiFi, Bluetooth, etc.) to connect to the network interface 307. The network interface 307 allows data to be transmitted between the input device 300 and other devices on the network 306, acting as the bridge between the device and the network 306 itself.

The operating system 360 can receive data and/or commands from a variety of sources and control systems, including smart home/business systems 310, which are applications that communicate with smart home/business interfaces 312 using a variety of technology, such as WiFi or Bluetooth. Other applications such as smart home automation systems 315 communicate with smart home automation interfaces 317 through a central hub or network 306 that connects devices. When a smart home/business system 310 or a smart home automation system 315 transfers data and/or commands to the operating systems 360 via its respective interfaces, the processor 345 will then process the data and/or commands and enact the appropriate actions, such as controlling the motorized actuators to raise or lower a microwave oven 280. Also, the bus 337 is a communication pathway that facilitates data transfer between different components within the operating system 360, allowing them to interact and exchange information effectively. Essentially, the bus 337 acts as a shared channel for data transfer between various parts of the operating system 360. For example, the bus 337 transfers data between the memory 347, the processor 345, and the input/output peripherals. Other alternatives to using a bus 337 include but not limited to networks 306, switch fabrics, crossbars, etc.

Additionally, the wireless remote control device 270 is a transmitter that sends signals to the operating system 360 using infrared, radio frequency, or other wireless technologies and methods. The remote control receiver 314 detects and decodes these signals, and subsequently, commands are then executed to control the operation of the present disclosure to allow at least vertical and horizontal movement. Voice command systems are additional methods that can communicate with the operating system 360 to operate the embodiment. Additionally, or alternatively, the embodiment can also consist of artificial intelligence (AI) technology, which can perform numerous functionalities such as analyzing data, performing machine learning, and making recommendations. Additionally, and/or alternatively, the present disclosure can consist of a handle configured to manually adjust the position of the embodiment, such as raising or lowering the embodiment, thereby raising or lowering a microwave oven, respectively.

The operating system 360 can also interface and communicate with sensors and perform safety functionalities such as detecting the position of the embodiment. For example, as the embodiment raises or lowers a microwave oven 280, position sensors can detect the location of objects or obstacles, such as kitchen counters and stoves/ranges, in order to prevent colliding into or striking them. Also, an embodiment of the present subject matter can include a temperature sensor that can detect and measure changes in temperature and will notify the user of temperature changes. For example, if an over-the-range microwave oven 280 is lowered too close to a hot stove, the temperature sensor would alert the user of the high temperature, and subsequently, the embodiment would adjust over-the-range microwave oven 280 away from the hot stove. The operating system 360 can also interface/communicate with a moisture sensor that will detect the presence of moisture. Having a moisture sensor could prevent electrocution when using a microwave oven 280. Some embodiments of the present disclosure can include motion sensors, whereas a maximum extension setting can prevent the embodiment from extending a microwave oven 280 beyond a certain point established by the user.

What is claimed is:

1. An adjustable mechanism for mounting a microwave oven comprising:
a wall mounting segment;
a microwave oven mounting segment;
a minimum of one back bracket configured to secure the microwave oven mounting segment to the present disclosure;
an extending/retracting segment comprising a minimum of one actuator, a minimum of one linkage mechanism, and a minimum of one mechanical slide, configured to allow at least vertical and horizontal movement;
a supporting plate segment configured to support the components of the extending/retracting segment to allow at least vertical movement;
an operating system configured to control the operation of the present subject matter; and
a wireless remote control device.

2. The adjustable mechanism for mounting a microwave oven as in claim 1, wherein the wall mounting segment further comprising a wall mounting plate, wherein said wall mounting plate secures the present subject matter to a wall or other support surfaces.

3. The adjustable mechanism for mounting a microwave oven as in claim 1, wherein the microwave oven mounting segment comprising microwave oven mounting brackets configured to attach to a microwave oven.

4. The adjustable mechanism for mounting a microwave oven as in claim 1, wherein the microwave oven mounting segment further comprising a microwave oven mounting plate configured to secure a microwave oven to the present disclosure, wherein after the microwave oven mounting brackets are attached to a microwave oven, said microwave oven mounting brackets are then connected to said microwave oven mounting plate, whereas said microwave oven mounting plate subsequently facilitates the connection of a microwave oven to the present disclosure.

5. The adjustable mechanism for mounting a microwave oven as in claim 1, wherein the microwave oven mounting plate further comprising middle brackets configured to allow the microwave oven mounting plate to extend and retract, whereas when the microwave oven mounting plate is extended or retracted to a desired length, said middle brackets are subsequently fastened to the microwave oven mounting plate to secure the desired length.

6. The adjustable mechanism for mounting a microwave oven as in claim 1, wherein a minimum of one back bracket is configured to attach to the microwave oven mounting plate, in which said back bracket subsequently facilitates the connection of the microwave oven mounting plate to the present disclosure.

7. The adjustable mechanism for mounting a microwave oven as in claim 1, wherein the extending/retracting segment further comprising a horizontal mechanism configured to allow at least horizontal movement for the present disclosure, whereas said horizontal mechanism consisting of the first actuator and a linkage mechanism, wherein as said first actuator extends, it causes said linkage mechanism to extend, triggering the linkage mechanism to move the present subject matter horizontally and away from a wall or other support surfaces.

8. The adjustable mechanism for mounting a microwave oven as in claim 1, wherein the extending/retracting segment further comprising a vertical mechanism configured to allow at least vertical movement for the present subject matter, whereas said vertical mechanism consisting of a second actuator, a third actuator, first mechanical slides, and second mechanical slides, wherein as the second actuator extends, it causes the first mechanical slides to extend, triggering the first mechanical slides to help move the present subject matter downward, thereby lowering a microwave oven; furthermore, as the third actuator extends, it causes the second mechanical slides to extend, triggering the second mechanical slides to help move the present subject matter upward, thereby lifting a microwave oven.

9. The adjustable mechanism for mounting a microwave oven as in claim 1, wherein the supporting plate segment further comprising a first vertical support plate, a second vertical support plate, and a third vertical support plate, configured to provide support primarily to the extending/retracting components of the vertical mechanism, thereby allowing at least vertical movement for the present disclosure, whereas said first vertical support plate, consisting of the second actuator and the first mechanical slides, wherein as the second actuator extends, it pushes against the second vertical support plate, causing the first mechanical slides to extend downward, triggering the second vertical support plate with the attached microwave oven mounting segment to move vertically downward, thereby lowering a microwave oven; moreover the third vertical support plate consisting of the third actuator and the second mechanical slides, wherein as the third actuator extends, it pushes against the first vertical support plate, causing the second mechanical slides to extend upward, triggering the first vertical support plate, which is attached to the second vertical support plate and thus connected to the microwave oven mounting segment, to move vertically upward, thereby lifting a microwave oven.

10. The adjustable mechanism for mounting a microwave oven as in claim 1, wherein the operating system comprising a minimum of one processor, memory, and input and output (I/O) peripherals, whereas a said processor configured to process and respond to various data and instructions/commands that direct the functions of the present subject matter, and said memory, consisting of volatile and non-volatile memory, configured to store data and instructions/commands, and said input and output (I/O) peripherals consisting of input and output (I/O) devices that enable communication between the operating system and users, and with other systems as well, whereas, said input devices configured to send data and instructions/commands to the operating system for performing tasks, and said output devices convert data and instructions/commands into a form that users can perceive.

11. The adjustable mechanism for mounting a microwave oven as in claim 1, further comprising a remote control receiver configured to receive and decode signals sent by the wireless remote control device, and subsequently, commands are then executed to control the operation of the present disclosure to allow at least vertical and horizontal movement.

12. The adjustable mechanism for mounting a microwave oven as in claim 1, further comprising a remote control pouch configured to store the wireless remote control device.

13. An adjustable mechanism for mounting a microwave oven comprising:
a wall mounting plate configured to attach to a wall or other support surfaces;
a microwave oven mounting segment;
an extending/retracting segment configured to allow at least vertical and horizontal movement;
a supporting plate segment configured to support the components of the extending/retracting segment to allow at least vertical movement;
an operating system configured to control the operation of the present subject matter; and
a wireless remote control device.

14. The adjustable mechanism for mounting a microwave oven as in claim 13, wherein the microwave oven mounting segment comprising microwave oven mounting brackets configured to attach to a microwave oven.

15. The adjustable mechanism for mounting a microwave oven as in claim 13, wherein the microwave oven mounting segment further comprising a microwave oven mounting plate configured to secure a microwave oven to the present disclosure, wherein after the microwave oven mounting brackets are attached to a microwave oven, said microwave oven mounting brackets are then connected to said microwave oven mounting plate, whereas said microwave oven mounting plate subsequently facilitates the connection of a microwave oven to the present disclosure.
